(19) United States
(12) Patent Application Publication
(10) Pub. No.: US 2018/0230949 A1
(43) Pub. Date: Aug. 16, 2018

(54) VARIABLE SECTION NOZZLE FOR AIRCRAFT NACELLE AND NACELLE FOR AN AIRCRAFT TURBOJET ENGINE INCLUDING SUCH A NOZZLE

(71) Applicant: Safran Nacelles, GONFREVILLE L'ORCHER (FR)

(72) Inventors: Olivier KERBLER, GONFREVILLE L'ORCHER (FR); Loïc GRALL, GONFREVILLE L'ORCHER (FR); Guillaume GLEMAREC, GONFREVILLE L'ORCHER (FR); Amadéo GALASSO, GONFREVILLE L'ORCHER (FR); José FAUGERAS, GONFREVILLE L'ORCHER (FR); Mélody SERISET, GONFREVILLE L'ORCHER (FR)

(73) Assignee: Safran Nacelles, GONFREVILLE L'ORCHER (FR)

(21) Appl. No.: 15/952,331

(22) Filed: Apr. 13, 2018

Related U.S. Application Data
(63) Continuation of application No. PCT/FR2016/052639, filed on Oct. 13, 2016.

(30) Foreign Application Priority Data
Oct. 13, 2015 (FR) 15/59743

(51) Int. Cl. F02K 99/00

(52) U.S. Cl. CPC F02K 99/00; F05D 2240/128; F05D 2220/323

(57) ABSTRACT

The present disclosure provides a variable section nozzle for an aircraft nacelle having a longitudinal axis. The variable section nozzle includes movable doors and at least one displacement device for displacing the movable doors between a reduced section position and a larger position. The movable doors include at least one first guide device and at least one second guide device, each operable to guide the displacement of the doors relative to a fixed structure of the nozzle. The second guide device is disposed downstream relative to the first guide device and each of the first and second guide devices provide a curvilinear path. In one form, the curvilinear paths are substantially circular and define a circular arc.

### CROSS-REFERENCE TO RELATED APPLICATIONS

This application is a continuation of International Application No. PCT/FR2016/052639, filed on Oct. 13, 2016, which claims priority to and the benefit of FR 15/59743 filed on Oct. 13, 2015. The disclosures of the above applications are incorporated herein by reference.

### FIELD

The present disclosure relates to a variable section nozzle for an aircraft nacelle as well as to a nacelle for an aircraft turbojet engine including such a variable section nozzle.

### BACKGROUND

The statements in this section merely provide background information related to the present disclosure and may not constitute prior art.

An aircraft is driven by several turbojet engines each housed in a nacelle also accommodating a set of ancillary actuation devices relating to its operation and ensuring various functions when the turbojet engine is in operation or shut-down. These ancillary actuation devices comprise in particular a mechanical thrust reverser actuation system.

A nacelle generally has a tubular structure along a longitudinal axis comprising an air inlet upstream of the turbojet engine, a mid-section intended to surround a fan of the turbojet engine, a downstream section which may house a thrust reverser means and intended to surround the combustion chamber of the turbojet engine. The tubular structure is generally ended with an ejection nozzle whose outlet is located downstream of the turbojet engine.

The modern nacelles are intended to accommodate a turbofan engine capable of generating, via the blades of the rotating fan, a hot air flow (also called “main flow”) coming from the combustion chamber of the turbojet engine, and a cold air flow (“secondary flow”) which circulates outside the turbojet engine through an annular passage, also called “secondary flow path.”

The term “downstream” means here the direction corresponding to the direction of the cold air flow penetrating the turbojet engine. The term “upstream” refers to the opposite direction.

Said secondary flow path is formed by an outer structure, called Outer Fixed Structure (OFS) and a concentric inner structure, called Inner Fixed Structure (IFS), surrounding the structure of the motor itself downstream of the fan. The inner and outer structures belong to the downstream section. The outer structure may include one or more sliding cowl(s) along the longitudinal axis of the nacelle between a position allowing the exhaust of the reverse air flow and a position preventing such an exhaust.

The nacelle ends with a main ejection nozzle comprising, on the one hand, an outer module, also called main flare or outer nozzle, placed in the structural continuity of the IFS and forming a trailing edge of the main ejection nozzle, and on the other hand, an inner module, also called ejection cone, the inner and outer modules together define a flow channel of the main flow exiting the turbojet engine.

The sliding cowl of the outer structure belongs to the rear section and has a downstream side, also called secondary flare, forming the secondary ejection nozzle aiming at channeling the ejection of the secondary air flow. This nozzle provides the major portion of the thrust required for the propulsion by imparting a velocity to the ejection flows. This secondary nozzle may be associated to an actuation system independent or not of that of the cowl allowing varying and optimizing the outlet section of the secondary flow depending on the flight phase in which the aircraft is.

Indeed, in the case of motors with very high bypass ratio, for reasons of aerodynamic optimization in order to ensure a proper operation of the fan and also to optimize the fuel consumption, it is quite advantageous to be able to adjust the section of the cold air flow outlet downstream of the nacelle: it is indeed useful to be able to increase this section during the departure and landing phases, and to reduce it during the cruising phases: this is often referred as adaptive nozzle, or even as “VFN” (Variable Fan Nozzle).

Conventionally, the variation of the outlet section of the cold flow is performed by means of actuators, for example hydraulic or electromechanical, allowing displacing all or part of the outer fairing of the nacelle, and in particular displacing doors, or flaps, forming movable portions relative to a fixed structure, which are rotated about an axis by means of the at least one of said actuators.

The doors of the adaptive nozzle should, in a closed position, be in continuity with a rear cowling, by respecting the inner and outer aerodynamic lines of the nacelle.

In the open position, the doors of the adaptive nozzle, or VFN doors, allow increasing the outlet section, while respecting a maximum opening angle which does not disturb the (convergent) motor thrust, and also a sufficient leakage for the objectives of improving the motor operability, reduction of noise and consumption.

However, the kinematics of such VFN doors provided with this type of mechanism, ensuring their rotation about an axis by means of an actuator, for example of the cylinder type, requiring a large stroke of said actuator because of the translation of the doors and the rotation in order to obtain the desired angle (divergent or convergent flow).

Furthermore, a large stroke of the actuator involves an adapted dimensioning of the outer structure and that of the door, that is to say larger, and consequently more cumbersome.

A possible solution would be to design actuators of small dimensions having a limited stroke. However, this type of mechanism does not allow obtaining a convergence of the flow with a sufficient flow rate for a limited stroke of the actuator.

### SUMMARY

The present disclosure relates to a variable section nozzle for an aircraft nacelle having a longitudinal axis, the nozzle comprising doors movable between a reduced section position and a larger section position, and at least one displacement device for displacing each of the doors between said positions, each displacement device including actuators and controls to control the actuators, the nozzle being characterized in that each of the doors comprises at least one first and one second guide device for guiding the displacement of the doors relative to a fixed structure of the nozzle, the second guide device being placed downstream relative to the first guide device, the first and second guide devices being arranged to provide each, at least locally, a substantially curvilinear path.

Such a structure allows, in particular thanks to the guiding of each door in at least two points thereof such that these points are distinct and distant longitudinally relative to each other, to obtain a displacement path of each of said doors which does not interfere with the inner aerodynamic lines of the nacelle. This also allows:

opening and moving the door forward in order to obtain a leakage for the desired air flow rate; and

limiting the angle of the door in order not to exceed an angle value which would generate a divergent flow.

Moreover, the presence of at least two remote guide devices distant longitudinally relative to each other allows countering more effectively the hoop stresses. Indeed, the thinner the thickness of a door is, the more the hoop stresses are to be countered. The presence of two guide devices thus allows providing an improved resistance of the nozzle during its use and using doors of reduced thickness. In the opposite case, with a single guide device, the door should be thicker.

Advantageously, each of the doors is delimited longitudinally, by an upstream edge and a downstream edge, and laterally, by two lateral flanks, each of the doors of the nozzle comprising at least one first and one second guide device at each of the lateral flanks thereof. In this manner, a first guide device is associated to a second guide device, this pair of first and second guide devices equipping each lateral flank of each door. This feature further allows countering more effectively the hoop stresses and reducing the thickness of the doors of the nozzle. This also allows providing a balance of the door during the use thereof and providing a balance of the pressures exerted thereon.

According to a particular technical feature, each door has a thrust center, said thrust center being, during the use of the nozzle, located longitudinally between the first and second guide devices, and in one form is substantially between 30% and 50% of an axial length of the door relative to the upstream edge.

Further advantageously, each of the doors has a center of gravity, said center of gravity being, during the use of the nozzle, located longitudinally between the first and second guide devices, and in one form is substantially between 30% and 50% of the axial length of the door relative to said upstream edge.

In a particular technical configuration, the first and second guide devices comprise at least one rail arranged to slide in at least one slide portion.

It will be noted that the term “rail” should be understood in a broad sense, such that it also covers rollers or bearings guided by tracks forming slides.

Concerning the slides, it will be noted that each guide device may have its own slide guiding the associated rail, or else the rails of the two guide devices might be guided by the same slide, these two rails being shifted longitudinally and being guided during the displacement of the door in different portions of this slide.

In the rest of the description, the terms “first rail” and “first slide rail” or “first slide portion” will refer to the rail and slide or slide portion of the first guide device. Similarly, the terms “second rail” and “second slide” or “second slide portion” will refer to the rail and slide or slider portion of the second guide device.

Still advantageously, the first and second guide devices, in particular the rail thereof, are spaced longitudinally relative to each other by a distance at least equal to ⅖, being 40%, of the axial length of the door taken between the upstream and downstream edges thereof.

According to an advantageous technical feature, the first guide device, in particular the first rail, is positioned longitudinally at a distance between 5% and 15% of the axial length of the door relative to its upstream edge, and in one variation, at a distance between 5% and 10% of the axial length of the door relative to its the upstream edge.

According to another feature, the second guide device, in particular the second rail thereof, is positioned longitudinally substantially between the middle and the downstream edge of the door, and in one variation, at a distance between 50% and 75% of the axial length of the door relative to the upstream edge thereof.

In one form, the paths provided by the first and second guide devices are substantially circular, each substantially describing a circular arc, and in one variation, the path described by the first guide device includes a concave portion oriented inwardly of the nozzle.

A radius of the first path may be selected such that its value is at least equal to twice the maximum thickness of the door, this thickness being measured radially relative to the nozzle, that is to say orthogonally to the longitudinal axis of said nozzle.

In this same case, where the first and second paths, provided respectively by the first and second guide devices, are substantially circular, the slides guiding the displacement of the rails each have a general circular arc shape. In this case, the rails also have a substantially circular arc shape. Such a shape of the rail allows improving the contact pressure of the rail in the associated slide.

According to a particular feature, the paths, a first and a second paths, provided respectively by the first and second guide devices, have a common path center.

In this case, the second path described by the second guide device has a concave portion also oriented inwardly of the nozzle.

Alternatively, in the case where their path centers are distinct, the second path described by the second guide device has a concave portion oriented outwardly of the nozzle. Such a configuration allows in particular a faster opening and closing of the door while respecting the aerodynamic requirements.

According to another particular feature, each of the doors comprises a groove in which is housed a stud secured to a fixed structure of the nozzle so as to form a locking system of said door.

According to an advantageous feature, the lateral flanks of each of the doors extend along a longitudinal direction and are substantially parallel.

Indeed, conventionally, the variable geometry nozzles have doors having substantially trapezoidal shapes. This type of trapezoidal doors has several drawbacks, in particular in that they cannot establish an aerodynamic continuity with the rest of the nozzle and the nacelle in the inactive position and involves the setting-up of complex mechanisms to move these doors.

On the contrary, the use of doors having substantially parallel lateral flanks allow, in particular, making the mechanisms for moving these doors simple and reliable and more simply providing the doors with the aerodynamic continuity, at least locally, of the nozzle.

Still advantageously, the nozzle comprises laterally, on either side of each door, at least one at least one lateral flap providing a lateral sealing to guide the flow when the associated door is driven outwardly of the nozzle. In one form, the lateral flaps are secured to the fixed structure of the nozzle.

The aforementioned terms “fixed” and “movable” are relative to the nozzle itself. It is understood that this fixed structure relative to the nozzle may be a movable structure relative to the nacelle. This is, moreover, the case when the nozzle is carried by a movable thrust reverser cowl.

According to another advantageous characteristic, at least one first and one second guide devices are integrated, together, in a guide structure comprising:

a box intended to be housed in a thickness of the fixed structure of the nozzle and to be fastened thereto by a removable fastening device, the box comprising a lower portion and an upper portion removable relative to each other;

a first portion of the first and second guide devices, carried by the box;

a second portion of the first and second guide devices, arranged to be positioned on the lateral flank of the associated movable door and arranged to movably cooperate with the first portion of the first and second guide devices, respectively; and

an adjustment device of the guide structure, and in one form, the adjustment device comprises at least one first height adjustment shim, in a radial direction of the nozzle, and at least one second width adjustment shim, in a transverse direction of the nozzle, orthogonal to the radial axis.

Such guide structures may be disposed on either side of each of the doors.

The removable fastening device being removable and the box being both housed in the thickness of the fixed structure and composed of two removable upper and lower portions, access to the guide device is then facilitated during maintenance and the aerodynamic drag is also reduced in flight.

Moreover, the refined adjustment of the position of the guide device allows an improved leveling of the associated VFN door with an outer cowling of the nozzle. The aerodynamic lines of the nacelle are thus improved and the aerodynamic drag is further reduced.

Finally, the box being supported by the fixed structure, the movable door is lighter.

According to a particular feature, the removable fastening device pass through, for example, radially relative to the nozzle, at least the lower portion of the box, the upper portion of the box and the height adjustment shim in order to be fixed in a beam of the fixed structure of the nozzle.

In a particular configuration, these fastening devices are screws and/or pegs.

According to another particular feature:

the width adjustment shim is secured to the second portion of the first and second guide devices; and/or

the height adjustment shim is secured to the first portion of the first and second guide devices.

Advantageously, in the assembled position, the upper portion of the box is covered by a cowling. This cowling may be either a portion of the outer cowling of the fixed structure of the nozzle, or a separate part secured by removable linking mechanisms.

In a particular configuration, the first portion of the first and second guide devices comprises slides, also called sheaths or sliding slots. The second portion of the first and second guide devices may, in this case, comprise rails, or pins, arranged to cooperate with said slides.

Moreover, the present disclosure also relates to a nacelle for an aircraft turbojet engine, characterized in that it comprises a variable section nozzle according to any one of the aforementioned features.

Advantageously, the doors of the nozzle are carried by a movable cowl of a thrust reverser, the door being longitudinally framed by an upstream portion of the movable cowl and by a trailing edge of said movable cowl. In other words, in this configuration the doors of the nozzle do not form the trailing edge of the secondary nozzle of the nacelle, that is to say that they do not form the downstream end of the nozzle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a turbojet engine nacelle for an aircraft according to the present disclosure;

FIG. 2 is a schematic sectional view of a turbojet engine nacelle according to the present disclosure;

FIGS. 3A and 3B are perspective views of a variable section nozzle of an aircraft nacelle according to the present disclosure;

FIG. 4 illustrates guide devices of a nozzle door according to one form of the present disclosure;

FIG. 5A is a sectional view of the nozzle of FIG. 4 in a reduced section position;

FIG. 5B is a sectional view of the nozzle of FIG. 4 in a larger section position;

FIG. 6 is a side view of a movable door of the nozzle of FIG. 4;

FIG. 7A is a sectional view of a nozzle provided, with guide devices, at a door, in a reduced section position according to the present disclosure;

FIG. 7B is a sectional view of a nozzle, provided with guide devices, at a door, in a larger section position according to the present disclosure;

FIG. 8 is a sectional diagram of a movable door illustrating paths provided by associated guide devices according to the present disclosure;

FIG. 9 is a sectional diagram of a movable door illustrating paths provided by associated guide devices according to the present disclosure;

FIGS. 10A and 10B illustrate two rear and front views of a door according to one form of the present disclosure;

FIG. 11 illustrates a view of a movable door provided with a guide structure at one of its lateral flanks according to one form of the present disclosure;

FIG. 12 is a perspective view of the movable door of FIG. 11;

FIG. 13 is a perspective view of the movable door of FIG. 11;

FIG. 14 is a sectional view of the guide structure of FIG. 11

FIGS. 15A and 15B are sectional views of the guide structure of FIG. 11;

FIG. 16 shows an exploded view of the guide structure according of FIG. 11;

FIG. 17A illustrates a first guide device according to the present disclosure;

FIG. 17B illustrates a second guide device according to the present disclosure; and

FIGS. 18A, 18B, 18C, 18D and 18E illustrates different steps of a dismounting method of a guide structure according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In all these figures, identical or similar references refer to identical or similar members or sets of members.

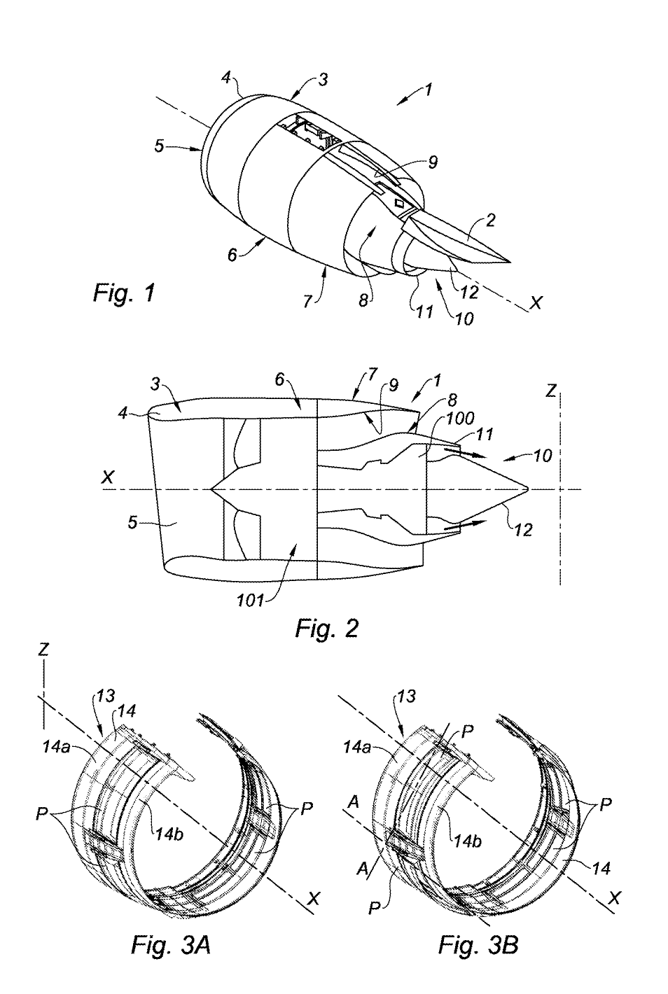

As shown in FIGS. 1 and 2, a nacelle 1 has a substantially tubular shape along a longitudinal axis X. This nacelle 1 is intended to be suspended from a pylon 2, itself fastened under a wing of an aircraft.

In general, the nacelle 1 comprises a front or upstream section 3 with an air inlet lip 4 forming an air inlet 5, a median section 6 surrounding a fan 101 of a turbojet engine 100 and a rear or downstream section 7. The downstream section 7 comprises an inner fixed structure 8 (IFS) surrounding the upstream portion 3 of the turbojet engine 100, and an outer fixed structure (OFS) 9.

The IFS 8 and the OFS 9 delimit an annular flow path called “secondary flow path” allowing the passage of a secondary air flow penetrating the nacelle 1 at the air inlet 5.

The nacelle 1 therefore includes walls delimiting a space, such as the air inlet 5 or the secondary flow path, into which the air flow enters, circulates and is ejected.

The nacelle 1 ends with an ejection nozzle 10 comprising an outer module 11 and an inner module 12. The inner 12 and outer 11 modules define a flow channel of a hot air flow exiting the turbojet engine.

The downstream section 7 of the nacelle further comprises an ejection nozzle 13 also called secondary nozzle aiming at channeling the ejection of the secondary air flow. This nozzle 13 provides the major portion of the thrust for the propulsion by imparting a velocity to the ejection flows. In the case where this nozzle 13 is carried by a movable thrust reverser cowl, this secondary nozzle may be associated to an actuation system independent or not of that of said movable cowl allowing varying and improving the outlet section of the secondary flow depending on the flight phase in which the aircraft is.

FIGS. 3A and 3B illustrate views of a variable section nozzle 13 of an aircraft nacelle 1 according to one form of the present disclosure. In these figures, the upstream of the nozzle 13 is shown on the left, and the downstream of the nozzle 13 is shown on the right. Thus, in operation, the air penetrates the air inlet 5 of the nacelle 1 and exits through the variable section nozzle 13. As indicated in the preamble of the present description, it is important to be able to vary the section of the nozzle 13, during the different phases of the flight of the aircraft.

In this form, this variation of the outlet section of the nozzle 13 is obtained by rotating doors P, here four in number, movable about respective axes A, these axes being substantially perpendicular to the longitudinal axis X of the nacelle 1.

These doors P are movable relative to a fixed structure 14 of the nozzle 13 between a reduced section position (see FIG. 3A) and a larger section position (see FIG. 3B).

In the following forms, the reduced section position corresponds to a closed position of the doors P, in which said doors P are positioned in the aerodynamic continuity of the nozzle 13. The larger section position corresponds for its part to a position in which the doors P are positioned at a maximum opening.

The fixed structure 14 of the nozzle 13 is intended to be fixedly secured to a movable thrust reverser cowl of the nacelle (not shown), this movable cowl being movable in translation relative to a fixed structure of the nacelle.

The doors P of the nozzle 13 are longitudinally framed by an upstream portion 14a and by a downstream portion 14b forming a trailing edge. In other words, in this configuration the doors P of the nozzle do not form the trailing edge of the secondary nozzle of the nacelle.

The nozzle 13 further comprises at least one displacement device 15 (see for example FIGS. 5A and 5B) for displacing each of the doors P between said reduced section and larger section positions. Each displacement device 15 includes actuators 16 and controls to control the actuators (not shown). These actuators 16 are cylinders connected to the doors P by a slider 17 guided in translation and by a connecting rod 18 in rotation both relative to the door P to which it is linked and relative to the slider to which it is linked.

Each of the doors is delimited longitudinally, by an upstream edge 19a and a downstream edge 19b, and laterally, by two lateral flanks 20, the connecting rod 18 being connected to the door P at the upstream edge 19a thereof.

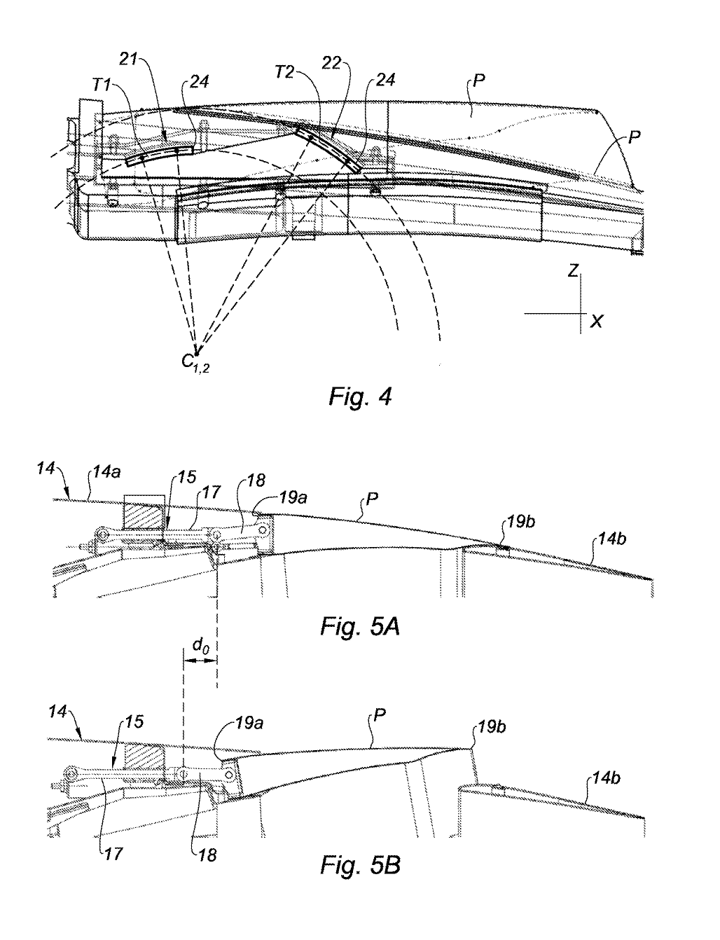

FIGS. 4, 5A, 5B and 6 illustrate guide devices according to a first form of the present disclosure.

In particular, FIG. 4 illustrates guide devices 21, 22 of a door P of a variable section nozzle 13 according to this first form of the present disclosure.

Indeed, each of the doors P comprises at least one first guide device 21 and one second guide device 22 for guiding together the displacement of the doors P relative to the fixed structure 14 of the nozzle 13.

The actuators 16 perform a substantially longitudinal rectilinear stroke do between 50 mm and 100 mm, according to one form. The stroke associated in particular with the connecting rod 18 and the guide devices 21, 22 allow displacing the door P between its two reduced section positions (see FIG. 5A) and a larger section position (see FIG. 5B). In one example, as illustrated in the figures (for example, FIGS. 5A and 5B), the kinematics of the doors P is configured such that:

the door moves from the reduced section position to the larger section position (direction of the opening of the section), when the cylinder is retracted, that is to say when the displacement device 15 displace the upstream edge 19a of the door P upstream; and

the door moves from the larger section position to the reduced section position (closure direction of the section), when the cylinder is deployed, that is to say when the displacement device 15 displace the upstream edge 19a of the door P downstream.

According to the present disclosure, the second guide device 22 is placed longitudinally along the axis X downstream relative to the first guide device 21, the first and second guide devices 21, 22 being arranged to provide each at least locally, at the point of the guided door, a substantially curvilinear path T1, T2.

In this manner, it is possible to design variable section nozzles 13 having improved kinematics while providing satisfactory stress resistance.

Such an arrangement allows in particular obtaining a displacement path of each of these said doors which does not interfere with the inner aerodynamic lines of the nacelle, this while allowing both opening and moving the door forward to the maximum in order to obtain a leakage for the desired air flow rate and limiting the angle of the door in order to not exceed an angle value which would generate a divergent flow.

Moreover, the presence of at least two guide devices 21, 22 shifted longitudinally relative to each other allow an improved resistance of the nozzle 13 during its use by counteracting the hoop stresses and using doors of reduced thickness.

It will be noted that these guide devices 21, 22 are not necessarily aligned along an axis parallel to the longitudinal axis X, the fact remains that the second guide device is upstream of the first guide device.

As is the case here, first and second guide devices 21, 22 are disposed, on either side of each of the doors P of the nozzle, such that they are associated in pairs on each side. In other words, each of the doors P of the nozzle 13 comprises a first guide device 21 and a second guide device 22 disposed at each of the lateral flanks 20 thereof.

In particular, the second downstream guide device 22 is disposed so as to be generally aligned longitudinally with the upstream guide device 21 to which it is associated. In particular, this allows more effectively countering the hoop efforts and reducing the thickness of the doors P of the nozzle 13 while improving their balance and pressures which are exerted thereon during their use.

Contrary to popular belief, the increase in the number of guide devices 21, 22, and therefore in the mass of the nozzle 13 is compensated by the decrease in the mass induced by an improved dimensioning of the elements of the nozzle 13. Therefore, this allows reducing the mass of the nozzle 13 thanks to an improved design of the kinematics of the movable doors P.

The balance of the doors P is further improved when each door has:

a thrust center which, during the use of the nozzle 13, is located longitudinally between the first and second guide devices 21, 22,

substantially between 30% and 50% of an axial length L of the door P relative to the upstream edge 19a; and/or

a center of gravity which, when using the nozzle 13, is located longitudinally between the first and second guide devices 21, 22, substantially between 30 and 50% of the axial length L of the door P relative to said upstream edge audit 19a.

As is the case here, the longitudinal positioning of all first guide devices 21 for the same door P, and/or for all doors P of the nozzle 13, is identical. Similarly, the longitudinal positioning of all second guide devices 22 for the same door P, and/or for all doors P of the nozzle 13, is identical.

More specifically, the first and second guide devices 21, 22 each comprise a rail 23 arranged to slide in at least one slide portion 24. The rail 23 is here secured to the door P while the slide portions 24 are each secured to the fixed structure 14 of the nozzle 13. The rails 23 comprise a plate at their base having orifices adapted so that said rail 23 is for example screwed laterally to the door P.

In this manner, each door P comprises two first rails 23, with a first rail 23 per lateral flank 20, and two second rails 23, with a second rail 23 per lateral flank 20.

In this form, the paths T₁, T₂ provided by the first and second guide devices 21, 22 are substantially circular, that is to say that they each substantially describe a circular arc. In particular, the paths T₁, T₂ are here given by the shape of the slides 24 each describing a circular arc (see FIG. 4).

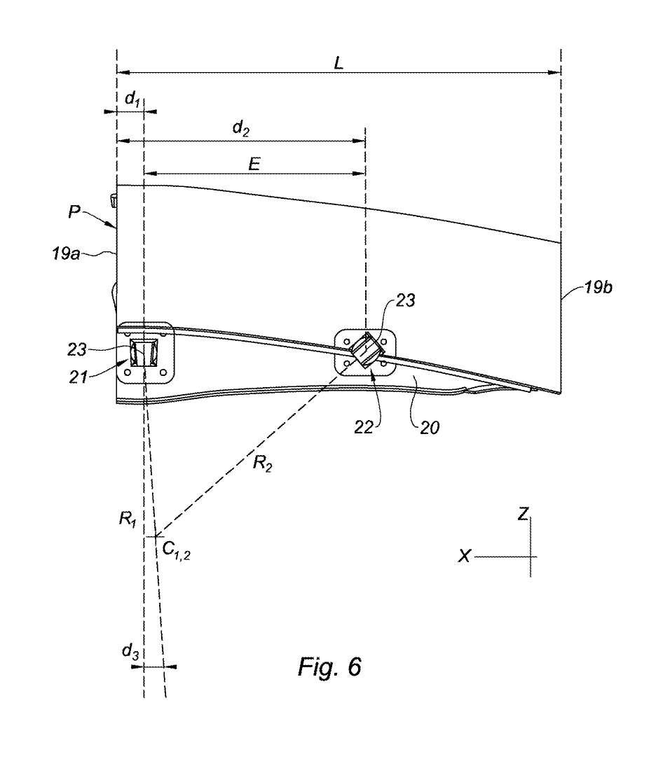

The rails 23, for their part, might have different shapes, such as an arc or circular arc shape (see for example FIG. 6), in spherical shape offering the advantage of being compatible with complex path curvatures, or even a barrel shape.

The shape of the circular arc-shaped rails 23 is here in particular adapted to the circular arc shape of the slides 24. Such a shape of the rail 23 allows improving the contact pressure of the rail 23 in the associated slide 24.

It will be noted that barrel-shaped rails allow for their part a better adaptability when the slides 24 delimit or follow a curvilinear path which is not in circular arc-shaped and which has different radii of curvature or that its radius of curvature is not constant.

The first and second guide devices 21, 22 are arranged such that the paths T₁, T₂ that they provide have a common center of path C_{1, 2}, or center of rotation here where the path is circular. This center of rotation C_{1, 2} is located at the secondary flow path. In this manner, the first and second paths T₁, T₂ described by the first and second guide devices 21, 22 each have a concave portion oriented inwardly of the nozzle 13.

The position of the first and second guide devices 21, 22 may vary depending on the axial length L of the associated door P taken between its upstream 19a and downstream 19b edges. Generally, the first and second guide devices 21, 22 are placed at predetermined zones of the door P so that the kinematics is improved while allowing an improved distribution of the forces for a reduced door P dimension.

It will be noted that, generally, the dimensions of the doors P such that their length L or the desired kinematics depend on several factors, including in particular:

the inner and outer aerodynamic lines (especially inner) of the nacelle 1 and in particular of the nozzle 13,

the percentage of increase of the desired outlet section,

the angle of the door P relative to the aerodynamic line, in particular, in the larger section position: this angle should not be too large to avoid disturbances of the outer line, such as for example between 5% and 10% relative to the longitudinal axis X, and in one form is about 7%, and

the width of the door: generally, the smaller the width of the door is, the more significant its length is, and conversely, this for stress resistance reasons in particular.

In particular, in this form, the length L of each of the doors P is comprised between 480 mm and 520 mm.

The first and second guide devices 21, 22 disposed together in pairs on each side of the doors P are disposed such that they are substantially aligned together longitudinally and that their longitudinal spacing E relative to each other is at least equal to ⅖, being 40%, of the length L of the door P. This distance E is here substantially comprised between 235 mm and 260 mm.

The position of the first and second guide devices 21, 22 is also chosen such that in the closed position of the nozzle 13:

the first guide device 21, in particular the first rail 23, is positioned longitudinally at a distance d₁ substantially comprised between 5% and 10% of the length L relative to the upstream edge 19a of the associated door P; and

the second guide device 22, in particular the second rail 23, is positioned longitudinally substantially between the middle, that is to say at mid-distance between the upstream 19a and downstream 19b edges, and the downstream edge 19b of the associated door P, and in one form positioned at a distance d₂ between 50% and 75% of the length L relative to the upstream edge 19a of the associated door P (see FIG. 6).

The distances d₁ and d₂ are here measured relative to the associated rail 23 secured to the door. This allows a more accurate position because the slide 24 should have a larger longitudinal dimension to guide the rail 23.

Moreover, in order to further improve the kinematics of the door P during its displacement, the radii R₁ and R₂ of the first and second paths T₁, T₂, each defined by the distance separating the center of path C_{1,2} to the first and second guide devices 21, 22, and in particular to their respective rail 23, are selected such that the radius R₁ is substantially comprised between 225 mm and 240 mm and the radius R₂ is substantially comprised between 335 mm and 350 mm. In a more general manner in this form, the radius R₂ of the second path T₂ is selected to be greater than the radius R₁ of the first path T₁.

In this manner, and since the center of rotation C_{1,2} of these two paths is the same, the movement of the door P locally at the second downstream guide device 22 is greater than the movement of the door P locally at the first upstream guide device 21 and provides the kinematics of the desired door P.

In general, the first and second guide devices 21, 22 are arranged so that said common center of path C_{1,2} is positioned longitudinally between the first and second guide devices 21, 22.

In this form, the center of path C_{1,2} is located longitudinally at a distance d₃ between 0 and 20 mm from the first guide device 21, in particular from its rail 23.

Moreover, the inclination of the first and second rails 23, namely the angles formed by the chords associated to each of these first and second rails 23 relative to the longitudinal axis X of the nozzle and the nacelle 1, in which the term “chord” means, the segment joining the ends of the arc formed by each of the rails, varies substantially between −5° and 0° for the first rail 23 and between 40° and 50° for the second rail 23.

Thanks to such a configuration, it is possible to obtain a displacement kinematics of each of the P doors which does not interfere with the inner aerodynamic lines of the nacelle, this while allowing opening and moving the door P forward to obtain a leakage for the desired air flow rate and limiting the angle of the door P in order not to exceed an angle value which would generate a divergent flow.

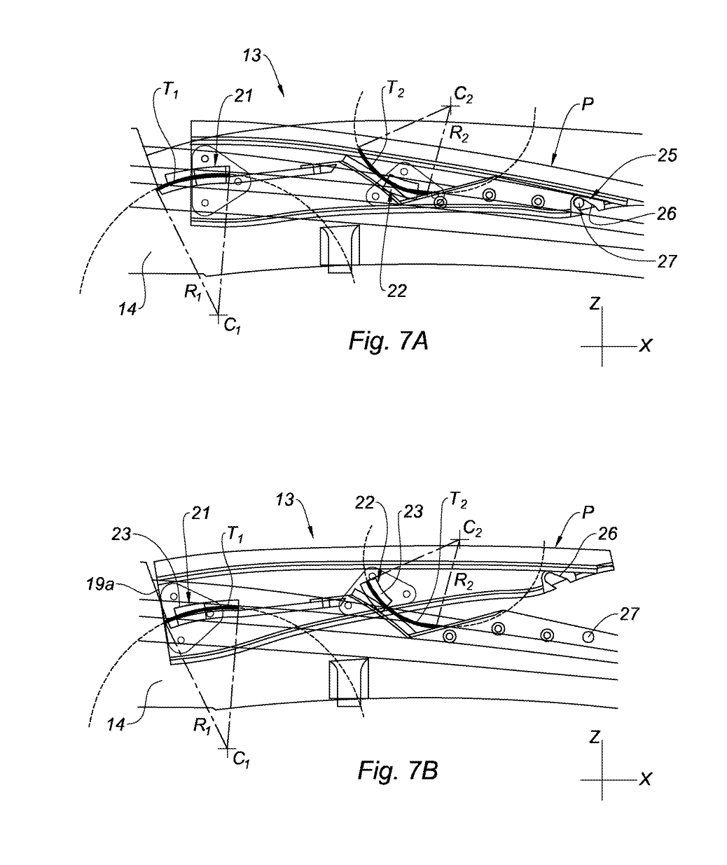

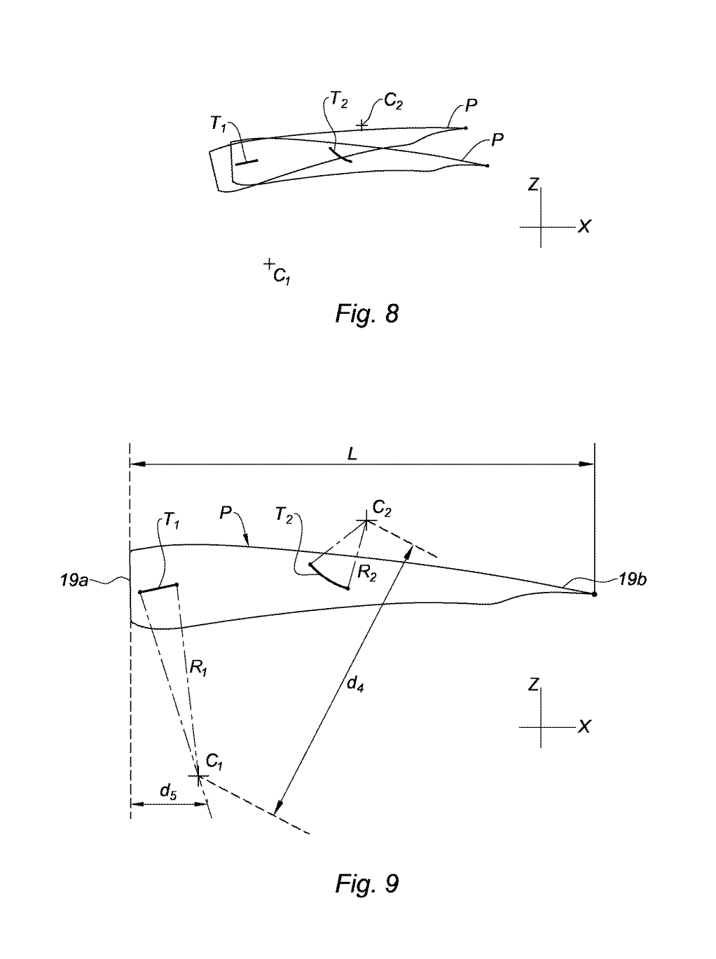

FIGS. 7A, 7B, 8 and 9 illustrate guide devices 21, 22 according to a second form of the present disclosure.

This second form essentially differs from the first form in that the paths T₁, T₂, provided by the first and second guide devices 21, 22 having centers of path, here of rotation, respectively a first center of path C₁ and a second center of path C₂, which are distinct.

Thus, the first path T₁ described by the first guide device 21 has a concave portion oriented inwardly of the nozzle 13 and the second path T₂ described by the second guide device 22 has an opposite concave portion, oriented outwardly of the nozzle 13.

The first center of rotation C₁ associated to the first path T₁ is always located at the secondary flow path.

Such a configuration allows in particular a faster opening and closing of the door P while respecting the aerodynamic requirements.

In this form the length L of each of the doors P is comprised between 480 mm and 550 mm.

The first and second guide devices 21, 22 for guiding each side of the doors P are also disposed such that their longitudinal spacing E relative to each other is at least equal to ⅖, being 40%, of the length.

In the same manner as in the form shown in FIGS. 4, 5A, 5B and 6, the position of the guide devices 21, 22 is selected such that in the closed position of the nozzle:

the first guide device 21, in particular the first rail 23, is positioned longitudinally at a distance d₁ comprised substantially between 5% and 15% of the length L relative to the upstream edge 19a of the associated door P; and that

the second guide device 22, in particular the second rail 23, is positioned longitudinally substantially between the middle, that is to say at mid-distance between the upstream 19a and downstream 19b edges, and the downstream edge 19b of the associated door P, and positioned at a distance d₂ comprised substantially between 50% and 75% of the length L relative to the upstream edge 19a of the associated door P.

The radii R₁ and R₂ of the first and second paths T₁, T₂ are here selected such that the radius R₁ is comprised substantially between 200 mm and 450 mm and the radius R₂ is comprised substantially between 60 mm and 100 mm.

The first and second guide devices 21, 22 are arranged such that the first center of path C₁ is positioned longitudinally between the first and second guide devices 21, 22 and such that the second center of path C₂ is positioned longitudinally between the second guide device 22 and the downstream edge 19b of the door P. In other words, the centers of paths are located longitudinally downstream of the associated guide devices.

The centers of rotation C₁, C₂ distinct from the paths T₁, T₂ provided by the first and second guide devices 21, 22 are spaced relative to each other by a distance d₄ comprised substantially between 60% and 70% of the length L of the door P (the considered distance d₄ is here a distance taken in the space and unreported longitudinally).

Moreover, and more generally, the center of rotation C₁ or C_{1,2} of the first path T₁ provided by the first guide device 21 is located:

longitudinally between the first and second guide devices 21, 22; and/or

longitudinally at a distance d₅ comprised substantially between 5% and 15% of the axial length L of the door P relative to the upstream edge 19a thereof.

The nozzle 13 further includes, for each of its doors P, at least one locking system 25 which comprises a groove 26 secured to the door P, or to the fixed structure 14, in which is housed a stud 27 secured to the fixed structure 14 of the nozzle 13, or respectively of the door P.

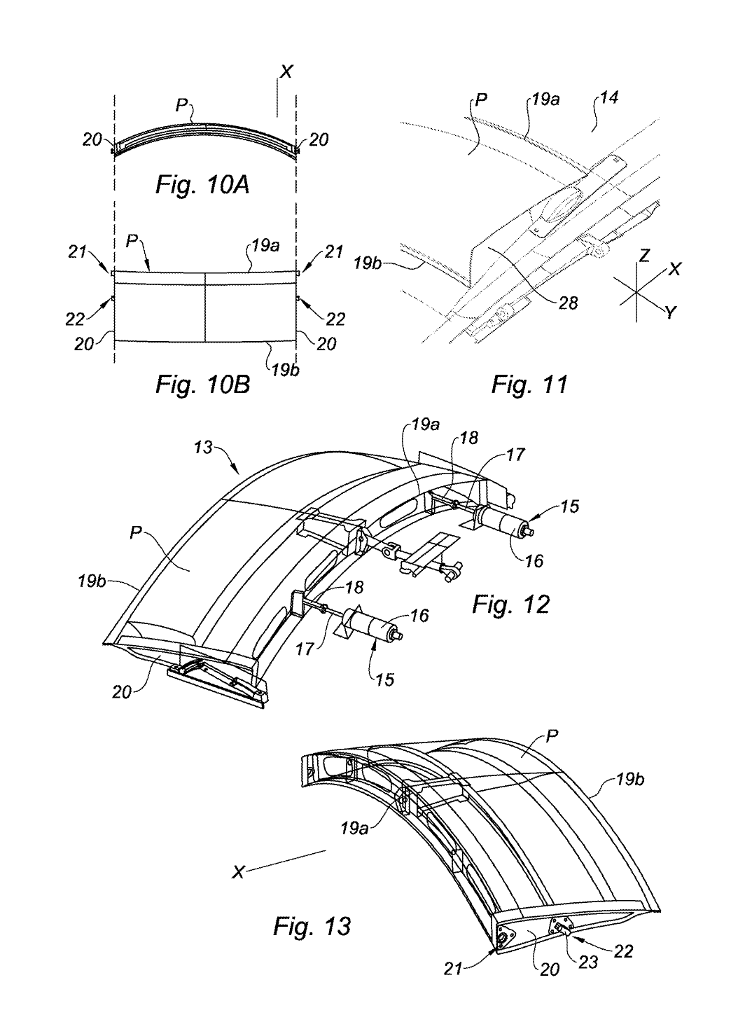

FIGS. 10, 11, 12 and 13 illustrate in particular a door P according to one form of the present disclosure.

In particular, it is particularly seen in FIGS. 10A and 10B that the lateral flanks 20 of the door P extend in the longitudinal direction X and are substantially parallel, at the same time to each other and to the longitudinal axis X. This allows making the movement mechanisms of these doors simple and reliable and more simply providing the doors with the aerodynamic continuity, at least locally, of the nozzle 13.

Moreover, the nozzle 13 has on either side of each of its doors P, a lateral flap 28 allowing in particular a lateral sealing in order to guide the flow when the associated door P is moved outwardly of the nozzle 13.

These lateral flaps 28 are here secured to the fixed structure 14 of the nozzle 13 and have a wall or panel shape raised radially relative to the nozzle 13 and protruding relative to the outer aerodynamic lines of the nozzle 13 and thus of the nacelle 1. This wall is increasingly protruding relative to the outer aerodynamic lines of the nozzle 13 from upstream to downstream. These lateral flaps 28 might be fixed or movable.

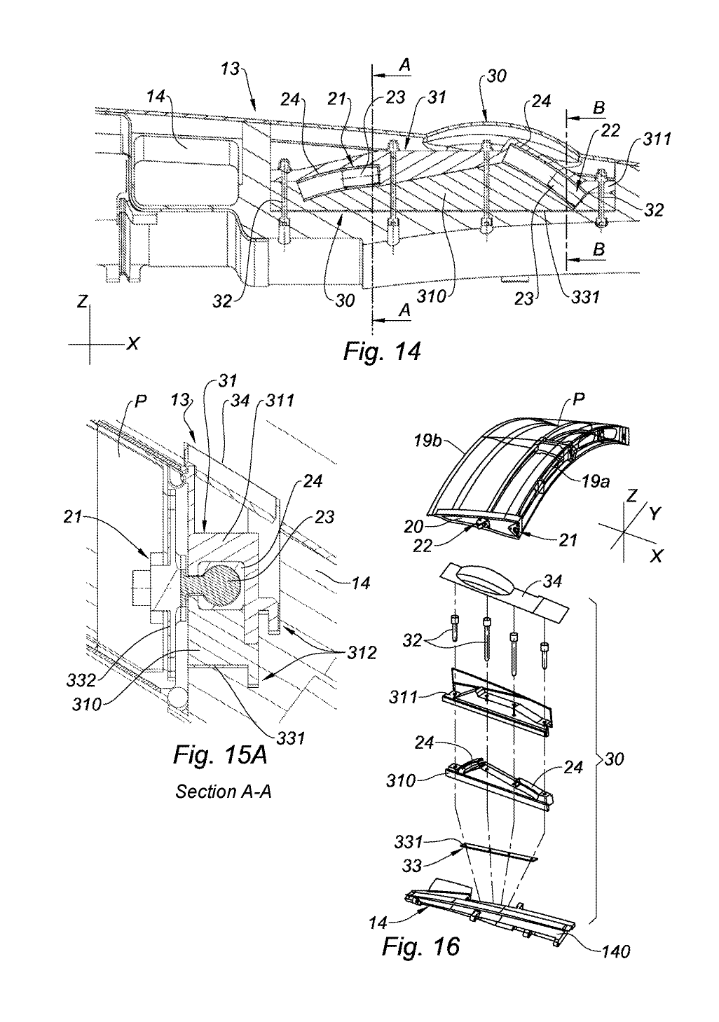

FIGS. 14, 15A, 15B, 16, 17A and 17B show an example of integration of a first and a second guide devices 21, 22 in an adapted guide structure 30, such a guide structure 30 being located laterally on either side of each of the doors P equipping the nozzle 13.

In these figures, the guide devices 21, 22 are those described in relation with FIGS. 5A, 5B and 6 except that the rails 23 do not have here a circular arc shape but a barrel shape (see for example FIG. 14).

The guide structure 30 here comprises:

a box 31 intended to be housed in a thickness of the fixed structure 14 of the nozzle 13 and to be fastened thereto by a removable fastening device 32, the box 31 comprising a lower portion 310 and an upper portion 311 removable relative to each other,

a first portion of the first and second guide devices 21, 22, carried by the box 31,

a second portion of the first and second guide devices 21, 22, arranged to be positioned on the lateral flank 20 of the associated movable door P and arranged to movably cooperate with the first portion of the first and second guide devices 21, 22, respectively; and

an adjustment device 33 of the guide structure 30.

The adjustment device 33 of the guide structure 30 comprises a first height adjustment shim 331, in a radial direction Z to the nozzle, and a second width adjustment shim 332, in a transverse direction Y of the nozzle, orthogonal to the radial axis Z, corresponding substantially to a direction tangential to the nozzle 13 at the first and second guide devices 21, 22.

The refined adjustment of the position of the first and second guide devices 21, 22 allows an improved leveling of the associated door P with an outer cowling of the nozzle 13. The aerodynamic lines of the nacelle 1 are therefore improved and the aerodynamic drag is reduced.

The first portion of the first and second guide devices 21, 22, carried by the box 31 is formed in particular by the slides 24 of the first and second guide devices 21, 22 while the second portion of the first and second guide devices 21, 22, arranged to be positioned on the lateral flank 20 of the associated movable door P and arranged to movably cooperate with the first portion of the first and second guide devices 21, 22, respectively, is formed in particular by the rails 23 of these said guide devices 21, 22, which are therefore arranged to cooperate with the associated slides 24.

Even if such a configuration is desired because it allows limiting the mass of the door P, it is not limiting and it might be considered in an alternative form (not shown) that the rails 23 are secured to the fixed structure 14 of the nozzle 13 and the slides 24 are secured to the door P.

Such a guide structure 30 allows an improved integration of a first guide device 21 and a second guide device 22 at each lateral flank 20 of each door P of the nozzle 13, said guide structure 30 being here disposed on either side of each of the doors P.

The fastening device 32 being removable and the box 31 being both housed in the thickness of the fixed structure 14 of the nozzle 13 and composed of two lower 310 and upper 311 portions removable relative to each other and in particular here also removable relative to the nozzle 13, access to the guide elements is then facilitated during the maintenance. Such a guide structure 30 also allows reducing the aerodynamic drag during a flight phase.

These removable fastening mechanisms 32 are here screws passing radially through the lower portion 310 of the box 31, the upper portion 311 of the box 31 and the height adjustment shim 331 in order to be fastened in a beam of the fixed structure of the nozzle 13.

Moreover, in this form, the width adjustment shim 332 is secured to the second portion, that is to say here rails 23, of the first and second guide devices 21, 22. The height adjustment shim 331 is secured to the first portion, that is to say slides 24, of the first and second guide devices 21, 22. Alternatively, these shims might be independent for each rail 23 and for each slide 24 of each of the guide devices 21, 22.

The adjustment of the leveling of the door P relative to the rear cowl is done here by the addition of shims 331 in order to limit the clearance.

The guide structure 30 further comprises, in the assembled position, a removable outer cowling 34 covering the upper portion 311 of the box 31. This cowling 34 may be either a portion of the outer cowling of the fixed structure 14 of the nozzle 13, or a distinct part secured by removable linking mechanisms.

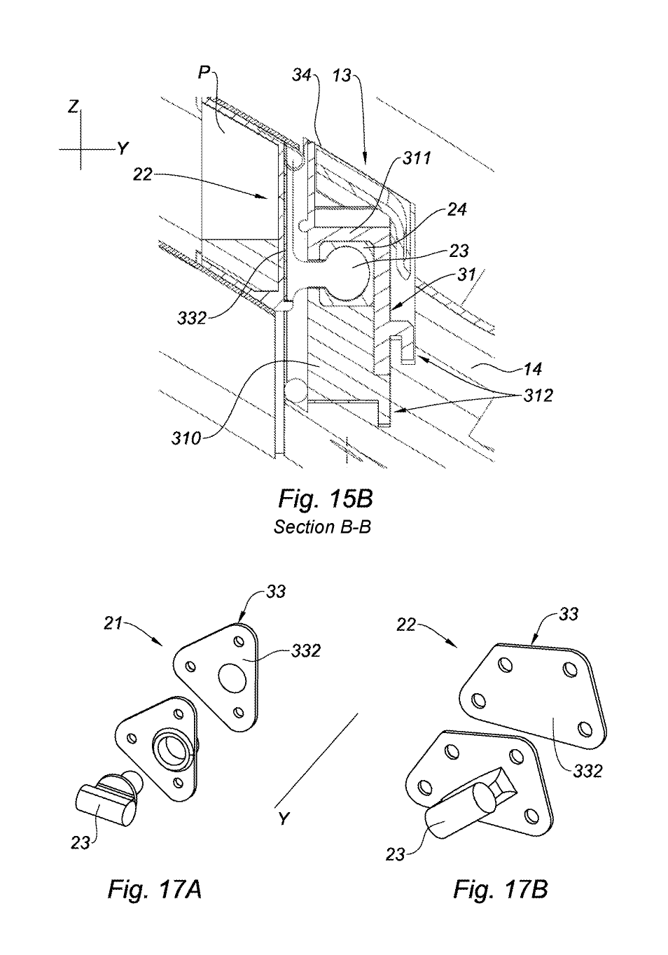

As is in particular shown in FIGS. 15A, 15B, 17A and 17B, the rail 23 of the first guide device 21 is hinged relative to its support formed here by the lateral flank 20 of the door. More specifically, the rail 23 is positioned free in rotation relative to the door P to which it is secured and about a transverse axis Y to the associated lateral flank 20.

On the contrary, the rail 23 of the second guide device 22 is fastened relative to the fixed structure 14 of the nozzle 13 to which it is secured. It is understood that, generally, the rail 23 may be either hinged, or fastened depending on the kinematics of the desired door P.

The lower portion 310 of the box 31 is positioned in the fixed structure 14 (rear cowl of the nacelle) by a tenon/mortise-type recovery effort system 312. The upper portion 311 of the box 31 is positioned in the same manner on the lower portion 310 of said box and in the fixed structure 14 of the nozzle 13.

The box 31 allows, thanks to its lower 310 and upper 311 portions, to sandwich, in one form radially, in the assembled position, the first portion, namely here the slides 24, of the first and second guide devices 21, 22, carried by the box 31. Indeed, the lower 310 and upper 311 portions of the box 31 are arranged to be superimposed and to cooperate together, the first portion of the first and second guide devices 21, 22 being interposed between these lower 310 and upper 311 portions of the box 31.

Such a configuration allows, with the removable fastening device 32, facilitating the mounting and dismounting of the guide structure 30 while providing a stress resistance which is adapted.

The use of the guide structure 30 is independent of the type of mechanisms (rotary, rail guide, mixture of several solutions, among others) and allows being able to perform a mounting, dismounting and simple adjustment in production and in maintenance.

Such a guide structure further allows proposing a way to house the first and second guide devices 21, 22 in the thickness of the inner and outer aerodynamic lines of the nozzle and the nacelle.

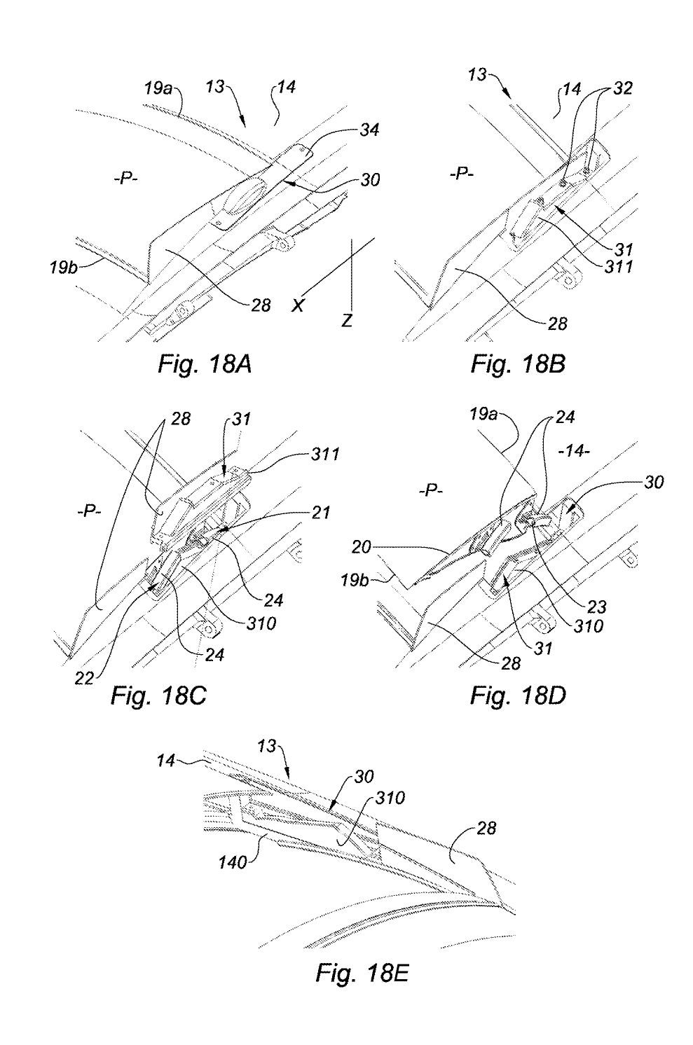

FIGS. 18A, 18B, 18C, 18D and 18E show steps of a dismounting method of this guide structure.

A dismounting method of the guide structure 30 includes the following steps:

a disengagement step of the cowling 34;

a dismounting step of the upper portion 311 of the box 31 by removing the removable fastening device 32;

a dismounting step of the lateral flank 20 of the door P associated with the first and second guide devices 21, 22; and

a disengagement step of the lower portion 310 of the box relative to the fixed structure 14 of the nozzle 13.

A mounting method of the corresponding guide structure 30 includes these same steps as the dismounting method but performed in a reverse order, that is to say:

a fastening step of the lower portion 310 of the box to the fixed structure 14 of the nozzle 13;

an insertion step of the lateral flank 20 of the door P associated with the first and second guide devices 21, 22;

a fastening step of the upper portion 311 of the box 31 via the removable fastening device 32; and

a setting-up step of the cowling 34.

In the illustrated steps, it will be noted that an upstream portion of the lateral flaps 28, located in line with the associated box 31, is here secured to the fixed structure 14 of the nozzle 13, but more specifically secured to the upper portion 311 of the box 31 and even in one-piece part. This facilitates the dismounting.

These steps might be implemented in order, for example, to add and/or remove adjustment shims 331, 332 to adjust the first and second guide devices 21, 22.

Such a guide structure 30 allows providing a mounting, dismounting and an adjustment of a VFN door in a workshop and/or maintenance which is simple, fast and accessible and that in an environment of small thickness for nacelles with very high bypass ratio.

The guide structure 30 may enclose at least one portion of the first and second guide devices 21, 22 in two lower 310 and upper 311 portions of the box 31, the whole may be height-adjustable, taking back the efforts mechanically by mortise tenons 312 and all assembled by bolts 32.

An architecture of a nozzle 13 provided with such guide structures 30 and their positioning in the upper (at 12 o'clock), lower (at 6 o'clock) and central (at 3 o'clock and 9 o'clock) portions relative to the nozzle 13 of the nacelle, in the beams 140 of the fixed structure 14 of said nozzle 13, reduces the growths outside the aerodynamic lines of the nacelle.

The nozzle 13 according to the present disclosure allows offering a solution implementing a simple kinematics by rail/slide of the door P in rotation and/or translation.

The present disclosure is described in the above by way of example. It is understood that those skilled in the art are able to carry out different variants of the present disclosure without departing from the scope of the present disclosure.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A variable section nozzle for an aircraft nacelle comprising:
movable doors configured to be displaced between a reduced section position and a larger section position; and
at least one displacement device for displacing the movable doors, each displacement device including actuators and a controller to control the actuators,
wherein each of the movable doors comprises at least one first guide device and at least one second guide device, the at least one first and second guide devices operable to guide the displacement of the movable doors relative to a fixed structure of the variable section nozzle,
wherein the at least one second guide device is disposed downstream relative to the at least one first guide device, the at least one first and the at least one second guide devices each providing, at least locally, a curvilinear path,
wherein the curvilinear path of at least the first guide device includes a concave portion oriented inwardly of the variable section nozzle.

2. The variable section nozzle according to claim 1, wherein each of the curvilinear paths of the at least one first and second guide devices are circular and define a circular arc.

3. The variable section nozzle according to claim 1, wherein each of the movable doors is delimited longitudinally by an upstream edge and a downstream edge, and delimited laterally by two lateral flanks, wherein at least one of the first guide device and at least one of the second guide device are located at each of the lateral flanks.

4. The variable section nozzle according to claim 1, wherein the at least one first and second guide device each comprises at least one rail arranged to slide in at least one slide portion.

5. The variable section nozzle according to claim 1, wherein the at least one first and second guide devices are spaced longitudinally, relative to each other, by a distance at least equal to 40% of an axial length of the movable door between an upstream edge and a downstream edge thereof.

6. The variable section nozzle according to claim 1, wherein at least one rail of the at least one first guide device and at least one rail of the at least one second guide device is spaced longitudinally, relative to each other, by a distance at least equal to 40% of an axial length the movable door between an upstream edge and a downstream edge thereof.

7. The variable section nozzle according to claim 1, wherein at least one of the at least one first guide device is positioned longitudinally at a distance between 5% and 15% of an axial length of the movable door relative to an upstream edge thereof, and the at least one second guide device is positioned longitudinally between a middle and a downstream edge of the movable door.

8. The variable section nozzle according to claim 7, wherein the at least one second guide device is positioned at a distance between 50% and 75% of the axial length of the movable door relative to the upstream edge thereof.

9. The variable section nozzle according to claim 1, wherein each curvilinear path has a common path center.

10. The variable section nozzle according to claim 1 further comprising at least one lateral flap on at least one side of each movable door that provides a lateral sealing to guide a flow when the movable door is driven outward from the variable section nozzle.

11. The variable section nozzle according to claim 1, wherein at least one first guide device and one second guide device are integrated together in a guide structure comprising:
a box housed in a thickness of a fixed structure of the variable section nozzle and fastened by a removable fastening device, the box comprising a lower portion and an upper portion removable relative to each other,
a first portion of the at least one first and second guide devices is carried by the box,
a second portion of the at least one first and second guide devices is arranged to be positioned on a lateral flank of the associated movable door and to movably cooperate with the first portion of the at least one first and second guide devices; and
an adjustment device comprising at least one first height adjustment shim in a radial direction of the variable section nozzle, and at least one second width adjustment shim in a transverse direction of the variable section nozzle, orthogonal to the radial axis.

12. A nacelle for an aircraft turbojet engine comprising a variable section nozzle according to claim 1.
